(19) United States
(12) Patent Application Publication
(10) Pub. No.: US 2014/0012764 A1
(43) Pub. Date: Jan. 9, 2014

(54) PROOF OF DEGRADATION TAGS FOR BIODEGRADABLE PLASTICS

(71) Applicant: Ezekiel Kruglick, Poway, CA (US)

(72) Inventor: Ezekiel Kruglick, Poway, CA (US)

(73) Assignee: Empire Technology Development LLC, Wilmington, DE (US)

(21) Appl. No.: 13/811,627

(22) PCT Filed: Jul. 3, 2012
(86) PCT No.: PCT/US12/45441

§ 371 Date: Jan. 22, 2013

(51) Int. Cl. G06Q 10/00

(52) U.S. Cl. CPC G06Q 10/30
USPC 705/308

(57) ABSTRACT

Technologies are generally described for proof of degradation for biodegradable materials through use of tags in items containing biodegradable materials. In order to incentivize actual degradation based recycling of biodegradable products, identification tags or trackers may be embedded into the biodegradable portion of such products. Tags may be selected such that a non-degradation destruction of the product would destroy the tags as well. At a recycling facility, information associated with the products may be obtained from the tags by separating the tags during degradation or collecting the tags themselves and providing the information or the tags to an entity such as the manufacturer, a government entity, or the like.

### BACKGROUND

Unless otherwise indicated herein, the materials described in this section are not prior art to the claims in this application and are not admitted to be prior art by inclusion in this section.

Plastics constitute a substantial portion (according to some studies approximately 11.8%) of the weight of municipal solid waste. Biodegradable plastics are seeing more and more use and have significant end-of-life benefits by not needing to be returned to origin or a high-energy consuming disposal process (e.g., burning). Unfortunately, a biodegradable plastic disposed of improperly—lacking airflow, moisture, temperature, microbes, etc.—may often not degrade at all, defeating the purpose of these materials. Sending biodegradable plastics to third world economies may thus be intended to provide affordable fertilizer for farms, but may also result in embarrassing pictures of consumer electronics plastic dumps despite spending large sums and publicizing the “biodegradable” properties of the plastic.

### SUMMARY

The present disclosure generally describes techniques for providing proof of degradation for biodegradable plastics employing embedded tags. According to some examples, a method for indicating proof of degradation for biodegradable materials may include embedding an identification tag into a biodegradable portion of an item comprising a biodegradable material such that the identification tag is separable from the item upon degradation, where the identification tag is destructible under one or more circumstances that destruct the item without the degradation.

According to other examples, a system for indicating proof of degradation for biodegradable materials may include an identification tag selection module configured to select a suitable identification tag for an item including a biodegradable material and an integration module. The integration module may be configured to embed the identification tag into a biodegradable portion of the item such that the identification tag is separable from the item upon degradation, where the identification tag is destructible under one or more circumstances that destruct the item without the degradation.

According to further examples, a method for providing proof of degradation for biodegradable materials may include separating an identification tag embedded into a biodegradable portion of an item comprising a biodegradable material during a degradation process; collecting item information from multiple separated identification tags; and providing the collected item information to an entity.

According to yet other examples, a system for providing proof of degradation for biodegradable materials may include a separation module, a collection module, and an administrative module. The separation module may be configured to separate an identification tag embedded into a biodegradable portion of an item comprising a biodegradable material during a degradation process. The collection module may be configured to collect item information from multiple separated identification tags. The administrative module may be configured to provide the collected item information to an entity.

According to some examples, a computer-readable storage medium may have instructions stored thereon for providing proof of degradation for biodegradable materials. The instructions may include separating an identification tag embedded into a biodegradable portion of an item comprising a biodegradable material during a degradation process; collecting item information from multiple separated identification tags; and providing the collected item information to an entity.

According to other examples, a computer-readable storage medium may have instructions stored thereon for indicating proof of degradation for biodegradable materials. The instructions may include embedding an identification tag into a biodegradable portion of an item comprising a biodegradable material such that the identification tag is separable from the item upon degradation, where the identification tag is destructible under one or more circumstances that destruct the item without the degradation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system, where proof of degradation for biodegradable plastics may be obtained employing embedded tags;

FIG. 2 illustrates an example injection molding process, where tags may be embedded into a biodegradable item for proof of degradation;

FIG. 3 illustrates some example tags that may be embedded into a biodegradable item;

FIG. 4 illustrates an example separation process using a magnetic roller;

FIG. 5 illustrates a general purpose computing device, which may be used to provide proof of degradation for biodegradable plastics employing embedded tags;

FIG. 6 is a flow diagram illustrating an example for embedding tags to ensure proof of degradation for biodegradable plastics;

FIG. 7 is a flow diagram illustrating an example method for providing proof of degradation for biodegradable plastics employing embedded tags that may be performed by a computing device such as the device in FIG. 5; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to proof of degradation for biodegradable plastics employing embedded tags.

Briefly stated, technologies are generally provided for proof of degradation for biodegradable materials through use of tags in items containing biodegradable materials. In order to incentivize actual degradation based recycling of biodegradable products, identification tags or trackers may be embedded into the biodegradable portion of such products. Tags may be selected such that a non-degradation destruction of the product would destroy the tags as well. At a recycling facility, information associated with the products may be obtained from the tags by separating the tags during degradation or collecting the tags themselves and providing the information or the tags to an entity such as the manufacturer, a government entity, or the like.

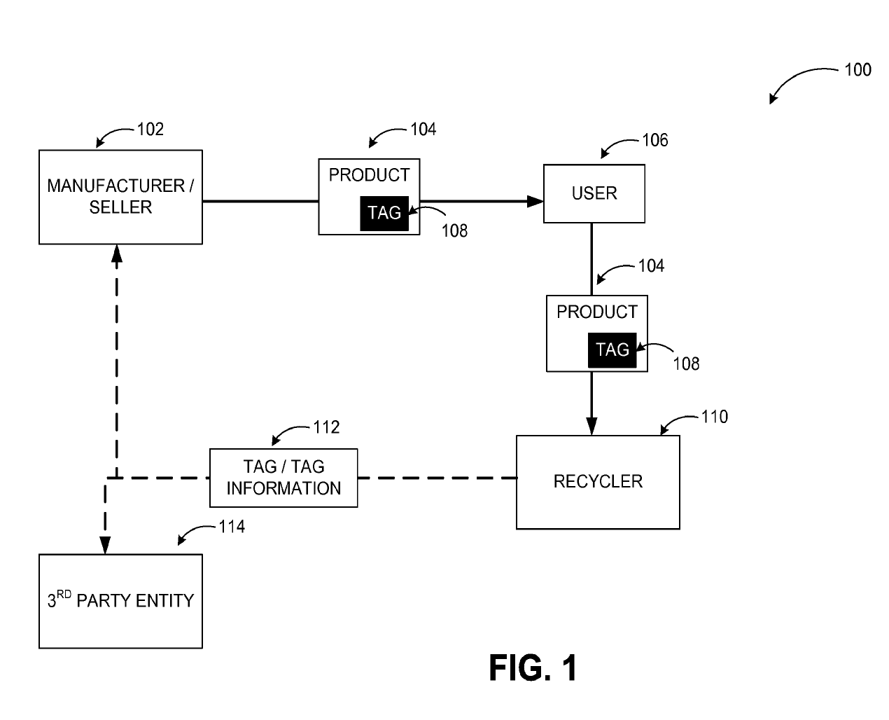

FIG. 1 illustrates an example system, where proof of degradation for biodegradable plastics may be obtained employing embedded tags, arranged in accordance with at least some embodiments described herein. As demonstrated in a diagram 100,

Diagram 100 shows an example life cycle of a biodegradable product 104. Biodegradable product 104 may be entirely biodegradable or may include portions that are biodegradable. Biodegradable product 104 may be provided (e.g., sold) by manufacturer or seller 102 to a user 106, who upon completion of their use of the product may provide it to a recycler 110 for proper recycling, which includes biodegradation of the degradable portions of the product. To ensure the product is properly recycled (i.e., biodegradable portions degraded), an identification tag 108 may be embedded into the biodegradable portion(s) of the product by the manufacturer or seller 102. The tag and/or information encoded onto the identification tag may be retrieved by the recycler 110 and provided (112) to the manufacturer or seller 102 or a third party entity 114. Typically, the recycler 110 may retrieve the tags. If the tags are RFID tags, they may be provided to a verifier to ensure that they were actually freed by degradation. In some cases, where the tags may be unreadable until recovered, the recycler may only return the information (e.g. optically read tags). In yet other examples, the tag information may be encrypted to ensure authentication.

The manufacturer or seller 102 (or another entity such as a government entity) may provide an incentive to the recycler 110 (or even the user 106) to ensure proper recycling. In order to receive the incentive, the recycler 110 may provide the tag and/or information encoded onto the identification tag (112) to the manufacturer or seller 102 or the third party entity 114. In some cases, the identification tag 108 may also be collected and provided as proof of recycling. The third party entity 114 may be a government entity, a commercial entity coordinating recycling efforts, an industry association, or similar ones.

Along with the many benefits that modern society has obtained from production and consumption, the high degree of household refuse and industrial disposal of materials such as plastics causes a high level of environmental concern. Plastics constitute a substantial portion of the weight of municipal solid waste. While recycling efforts continue to increase, disposal in landfills and incineration are still major approaches to dealing with refuse. On the other hand, increased public awareness and new regulations are leading to increased pressure on manufacturers to use recyclable (e.g., biodegradable) materials.

While many organizations are making a substantial push into using more “biodegradable” materials, these materials are not biodegradable in the same sense as banana peels, for example. Typically, appropriate temperature and moisture levels are needed in composting piles, and the piles need to be mixed multiple times. Some embodiments are directed to using various types of tags embedded into biodegradable products (or biodegradable portions of products) in such a way that the tags can be separated from the products during the biodegradation process and collected as proof of degradation. One example implementation may include magnetic properties of the tags such that the tags can be separated using a magnetic field from degraded (or degrading) product parts.

A system according to some embodiments may include four major aspects: (1) suitable product tracking elements; (2) embedding of tracking elements in products; (3) recovery of the tracking elements and thwarting of fraudulent methods; and (4) a financial model to support the tag based degradation corroboration.

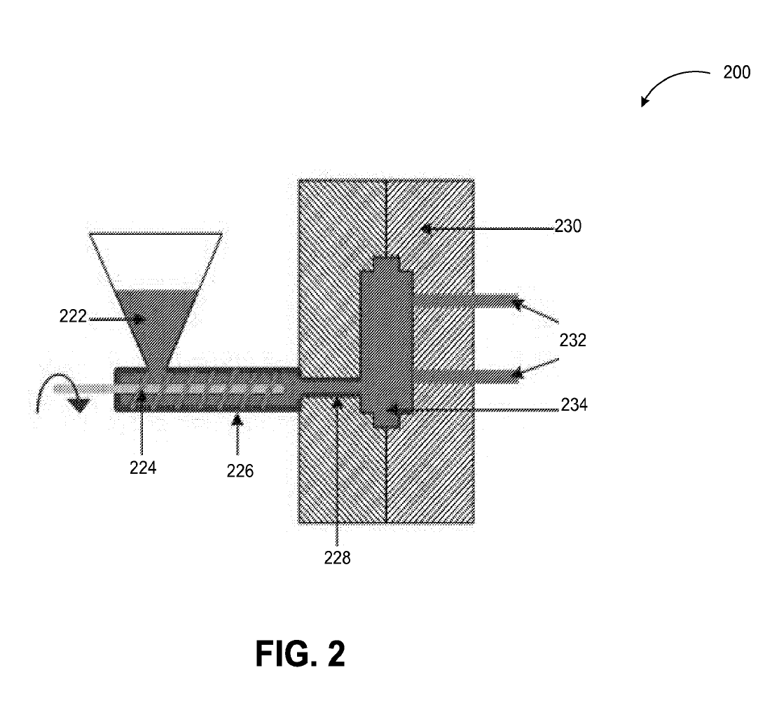

FIG. 2 illustrates an example injection molding process, where tags may be embedded into a biodegradable item for proof of degradation, arranged in accordance with at least some embodiments described herein.

Diagram 200 is an example system for embedding tracking elements into a product, for example, a plastic based product. A recoverable identification tag for providing proof of degradation may not only need to be embedded within a product, but the embedding may make it harder to recover the tag in one piece without composting. The aim is to embed the recoverable tag inside a piece of biodegradable plastic large enough that it cannot be meaningfully separated unless the plastic is removed by degradation. One of the common manufacturing strategies for plastics is injection molding. In injection molding, a negative mold 230 of an object may receive injected plastic at a temperature elevated to allow flow through a nozzle 228. The flowable plastic may start in powder form 222 and be liquefied as it is heated and pushed through a cylinder 226 by a screw 224 or similar pressure applying mechanism. As the liquefied plastic fills a cavity 228 in the negative mold 230, it may be allowed to cool taking the hard form of the intended object.

In a system embedding recoverable tags in a biodegradable plastic at the injection molding stage, one or more tags may be held in place within the injection molding cavity 228 by plastic standoffs attached to ejector pins 232. Thus, when the plastic object hardens, one or more identification tags may be buried within the object and only recovered upon degradation of the plastic through, for example, mechanical agitation and/or magnetic separation. To prevent fraudulent uses and to ensure the tags cannot be removed by, for example, burning the plastic object, the tags may be selected to be damaged at temperatures that would burn or liquefy the plastic.

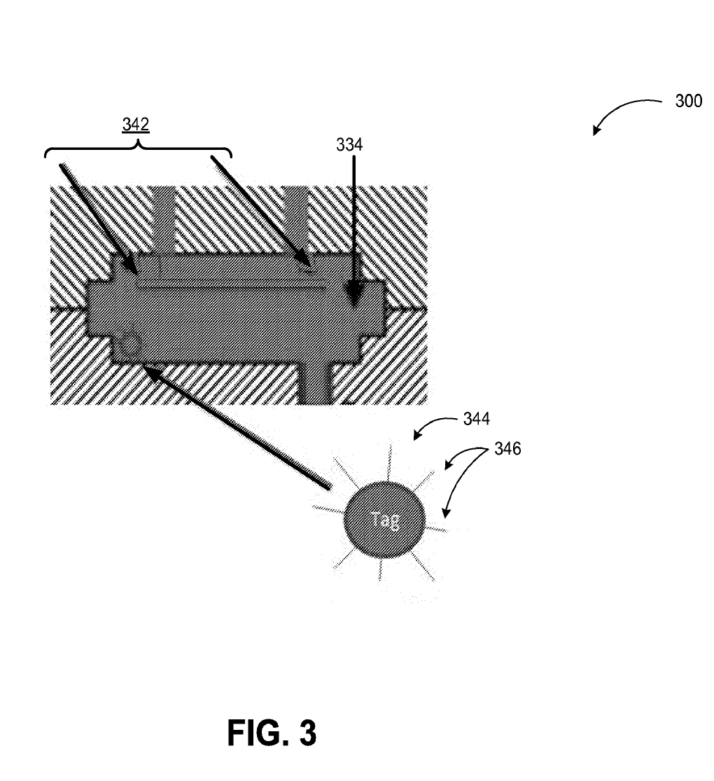

FIG. 3 illustrates some example tags that may be embedded into a biodegradable item, arranged in accordance with at least some embodiments described herein.

A wide variety of identification tags may be used to provide proof of degradation for biodegradable materials. For example, surface tags such as holograms may be rendered magnetically recoverable by adding ferrous powder to the mix for the metallic backing. Other examples of suitable identification tags may include a barcode tag, an acousto-magnetic label, a micro-wire tag, an optical reflection tag, or a radio frequency identification (RFID) tag.

Diagram 300 shows two distinct types of example tags embedded into an injection molded object such as the object discussed in FIG. 2. Depending on a size and shape of the object, a relatively large, flat tag 342 may be held in place through plastic attachments within the injection cavity 334 during the injection process. In another example, a relatively smaller (e.g., one with a substantially cylindrical or spherical shape) tag 344 may be embedded using small protrusions 346 or “hairs” of material such that the tag itself is held away from the surface of the mold to prevent visibility from the surface. The small protrusions 346 may be clear or match a color of the plastic they are embedded in. In other examples, a color or appearance of the small protrusions 346 may be irrelevant to the manufacturer.

In either of the above-discussed examples, the tag is not visible or accessible until the plastic is decomposed. Other examples approaches that may be used, if injection molding involves disrupted flow lines or thermal gradients due to the tags, may include placing tags between parts that are bonded through sonic welding, riveting, thermal staking, radio frequency (RF) staking, or similar methods.

In addition to the above discussed techniques for macroscopic product-specific tags, trackers such as micro-scale trackers, meso-scale trackers, milli-scale trackers, micro-taggants, rare earth oxides, or micro-particles may be embedded into the biodegradable materials to identify biodegraded items and an amount of biodegraded material. Such trackers may be produced in bulk using a material or coating that can provide magnetic or ferromagnetic properties, for example, for subsequent separation from the biodegradable items during degradation. Smaller scale trackers may be appropriate for products with thin walls or transparency, where a macroscopic tag may be undesirable. In other examples, a combination implementation may include a tracker representing the material and one or more tags indicating particular products, serial numbers, etc. In this scenario, both the material and products can be independently verified to different bodies by separating the different trackers and tags.

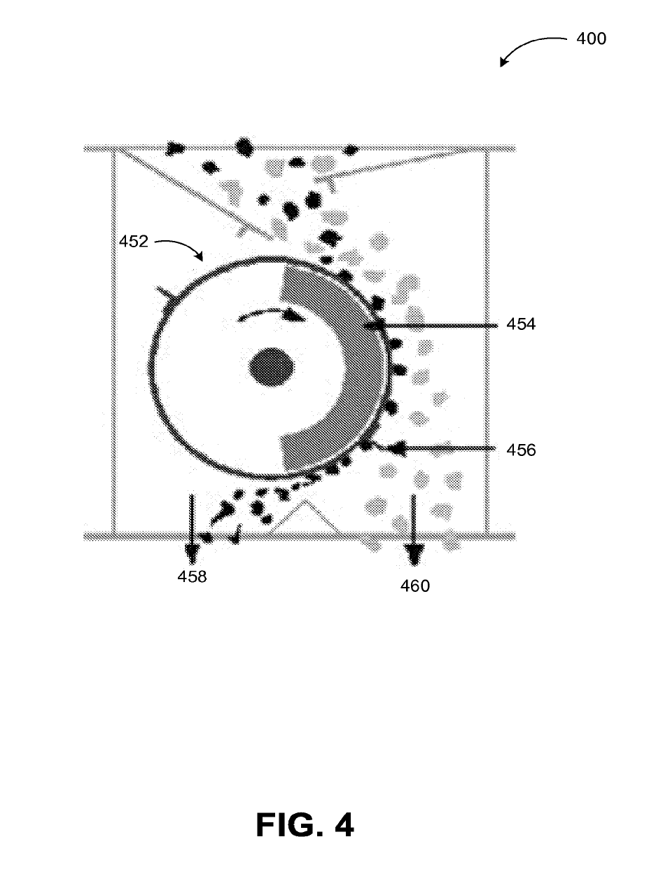

FIG. 4 illustrates an example separation process using a magnetic roller, arranged in accordance with at least some embodiments described herein.

A typical example of biodegradation is composting. Composting facilities may place composting materials in large piles composed of mixes of soil, moisture, and biodegradables of various sizes to manage airflow. At several points during the composting process the composting piles are “turned” or mixed. In some example embodiments, the compost pile may be passed through a form of size sorting at turning time so that decomposed particulates can be extracted and fragments of different sizes can be mixed together in the right ratios to promote continued decomposition. This sorting may be performed on belts or in rotary sifters and embedded tags may be separated from degrading materials through magnetic or mechanical means at that point of the degradation process.

Diagram 400 shows an example rotary magnetic separator. As the mix of biodegradable material pieces and tags or trackers (460 and 458) are passed through a rotating drum 452, at least a portion 454 of the rotating drum 452 may be magnetized (permanently or temporarily) causing the tags or trackers 458 with magnetic properties to stick to the drum and be separated from the biodegradable material. Subsequently, a kickoff part 456 or comparable mechanism (e.g., turning off the magnetization of the rotating drum 452 at selected time points) may cause the tags or trackers 458 to be deposited separately from the biodegradable material pieces 460.

In other examples, a separator over a belt frame may separate ferrous or magnetic bits as material passes under it, and a set of trough separators may receive the material to be collected subsequently in different basins. In yet other examples, a magnet behind the suspended top belt may pull magnetic material out of the mixed material passing by on the belt underneath and the magnetic material may be moved to drop off the belt at a chute. In further examples, mechanical sorting methods may also be used depending on relative sizes of the tags and biodegradable material pieces.

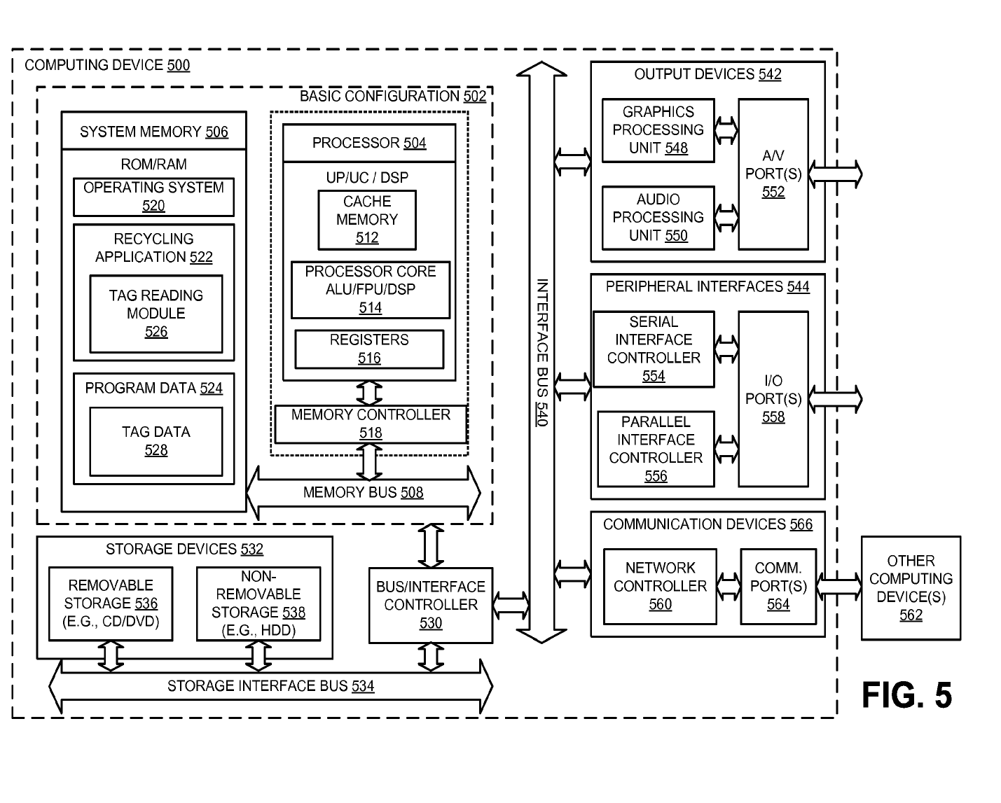

FIG. 5 illustrates a general purpose computing device, which may be used to provide proof of degradation for biodegradable plastics employing embedded tags, arranged in accordance with at least some embodiments described herein. In a basic configuration 502, a computing device 500 typically includes one or more processors 504 and a system memory 506. A memory bus 508 may be used for communicating between a processor 504 and system a memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level cache memory 512, a processor core 514, and one or more registers 516. An example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a recycling application 522, and program data 524. The recycling application 522 may include a tag reading module 526 that is arranged to obtain information associated with a product upon separation of a tag embedded into a biodegradable portion of the product during a degradation process. In addition to obtaining information (“reading”) from the tags embedded into biodegradable products, the tags themselves may also be collected as proof of biodegradation in some examples. In some embodiments, APIs may be provided that can be accessed by other entities and applications to obtain the proof of degradation. Program data 524 may include tag data 528 and other similar data. The tag data 528 (along with the tags as proof of degradation) may be used in providing reports to manufacturers, third party entities, or government entities proving degradation based recycling of biodegradable products. This described basic configuration 502 is illustrated in FIG. 5 by those components within the inner dashed line.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 500 may also be implemented as a personal computer including both laptop computer and non-laptop computer configurations. Moreover the computing device 500 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

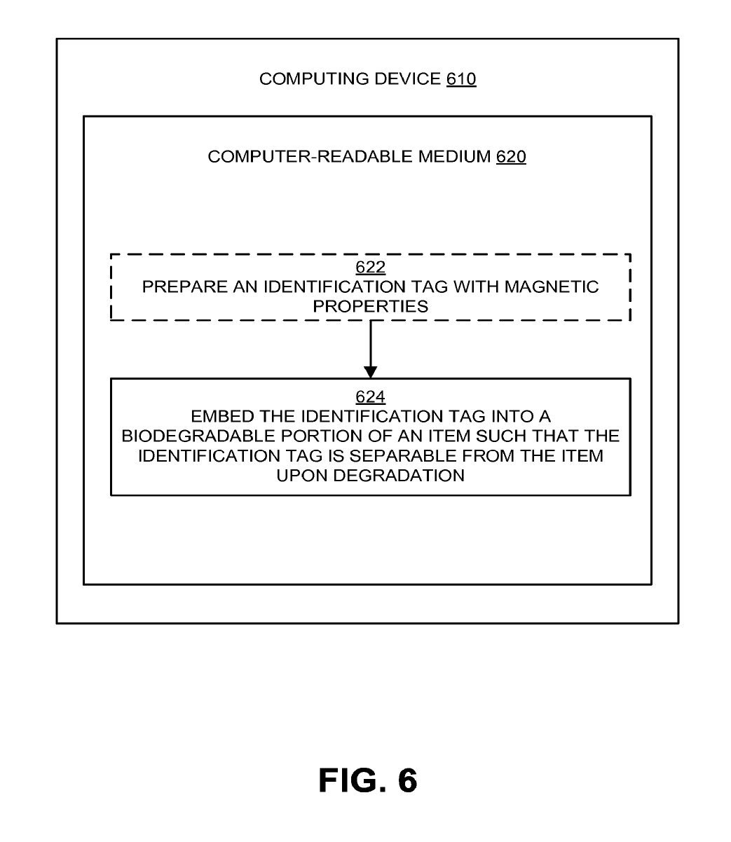

FIG. 6 is a flow diagram illustrating an example for embedding tags to ensure proof of degradation for biodegradable plastics, arranged in accordance with at least some embodiments described herein.

Example methods for embedding tags to ensure proof of degradation for biodegradable plastics may include one or more operations, functions or actions as illustrated by one or more of blocks 622 and/or 624. The operations described in blocks 622 through 624 may also be stored as computer-executable instructions in a computer-readable medium such as a computer-readable medium 620 of a computing device 610.

A process for embedding tags to ensure proof of degradation for biodegradable plastics may begin with optional block 622, “PREPARE AN IDENTIFICATION TAG WITH MAGNETIC PROPERTIES.” At optional block 622, one or more identification tags may be prepared with magnetic properties for subsequent separation and collection during a degradation process. This may be accomplished by adding a ferrous powder to a tag backing material, employing a ferro-magnetic tag coating, or preparing the tag with one or more tag components through comparable methods. In some examples, the identification tag may also be magnetized during manufacturing of the identification tag, prior to embedding the identification tag into the item, after embedding the identification tag into the item, or prior to separation at the degradation facility.

Optional block 622 may be followed by block 624, “EMBED THE IDENTIFICATION TAG INTO A BIODEGRADABLE PORTION OF AN ITEM SUCH THAT THE IDENTIFICATION TAG IS SEPARABLE FROM THE ITEM UPON DEGRADATION.” At block 624, the identification tag may be embedded, for example, during an injection molding process such that the tag is not visible on a surface of the item. In other example, the identification tag may be placed between parts of the item that are bonded, where the parts of the item may be bonded through sonic welding, riveting, thermal staking, or radio frequency (RF) staking.

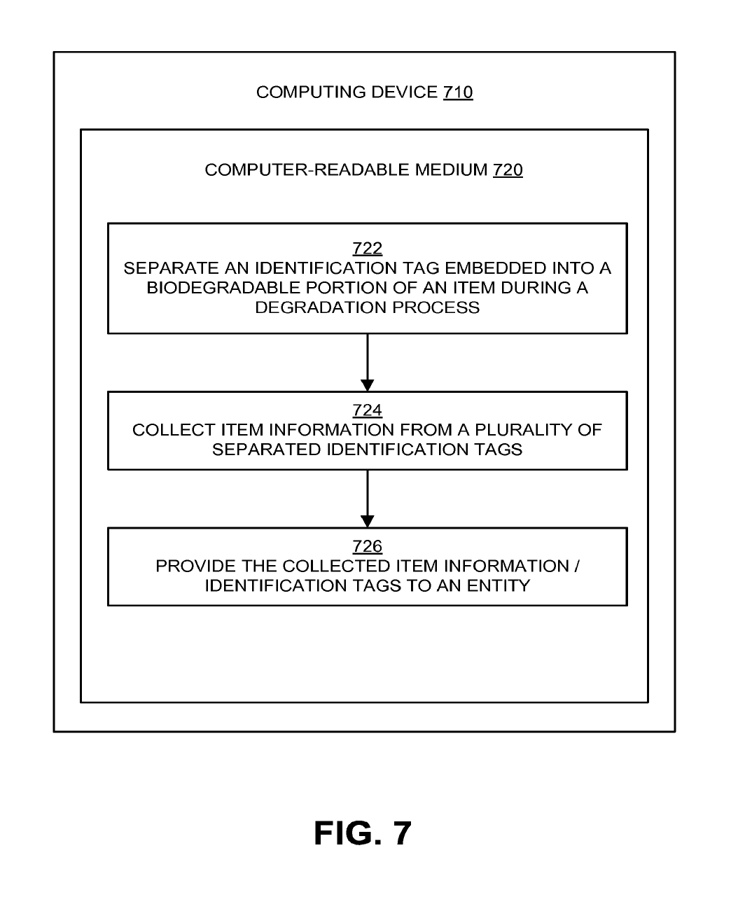

FIG. 7 is a flow diagram illustrating an example method for providing proof of degradation for biodegradable plastics employing embedded tags that may be performed by a computing device such as the device in FIG. 5, arranged in accordance with at least some embodiments described herein.

Example methods for providing proof of degradation for biodegradable plastics employing embedded tags may include one or more operations, functions or actions as illustrated by one or more of blocks 722, 724, and/or 726. The operations described in blocks 722 through 726 may also be stored as computer-executable instructions in a computer-readable medium such as a computer-readable medium 720 of a computing device 710.

A process for providing proof of degradation for biodegradable plastics employing embedded tags may begin with block 722, “SEPARATE AN IDENTIFICATION TAG EMBEDDED INTO A BIODEGRADABLE PORTION OF AN ITEM DURING A DEGRADATION PROCESS.” At block 722, the identification tag may be separated during size sorting so that decomposed particulates are extracted and fragments of different sizes are mixed together in ratios to promote continued decomposition. The identification tag may also be separated on a belt or a rotary sifter through magnetic sifting, where the identification tag is prepared with magnetic properties as discussed above.

Block 722 may be followed by block 724, “COLLECT ITEM INFORMATION FROM A PLURALITY OF SEPARATED IDENTIFICATION TAGS.” At block 724, information encoded onto the tags may be obtained such as by interrogating an RFID tag with an RFID reader or optically reading an optical tag. The information may be used to provide detailed information to an entity about the degraded product(s) such as serial number, lot, etc. In other examples, small-scale trackers may be used and a number of trackers may be determined to estimate an amount (e.g., weight) of degraded product.

Block 724 may be followed by block 726, “PROVIDE THE TAG AND/OR COLLECTED ITEM INFORMATION TO AN ENTITY.” At block 726, the tag(s) and optionally the information obtained from the tag(s) may be provided for receiving an incentive or for complying with a recycling regulation to the manufacturer, a third party entity, or a government entity. In other examples, the tags (or trackers) may also be collected and provided as proof of degradation.

The blocks included in the above described processes are for illustration purposes. Embedding tags to ensure proof of degradation for biodegradable plastics and providing proof of degradation for biodegradable plastics employing embedded tags may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

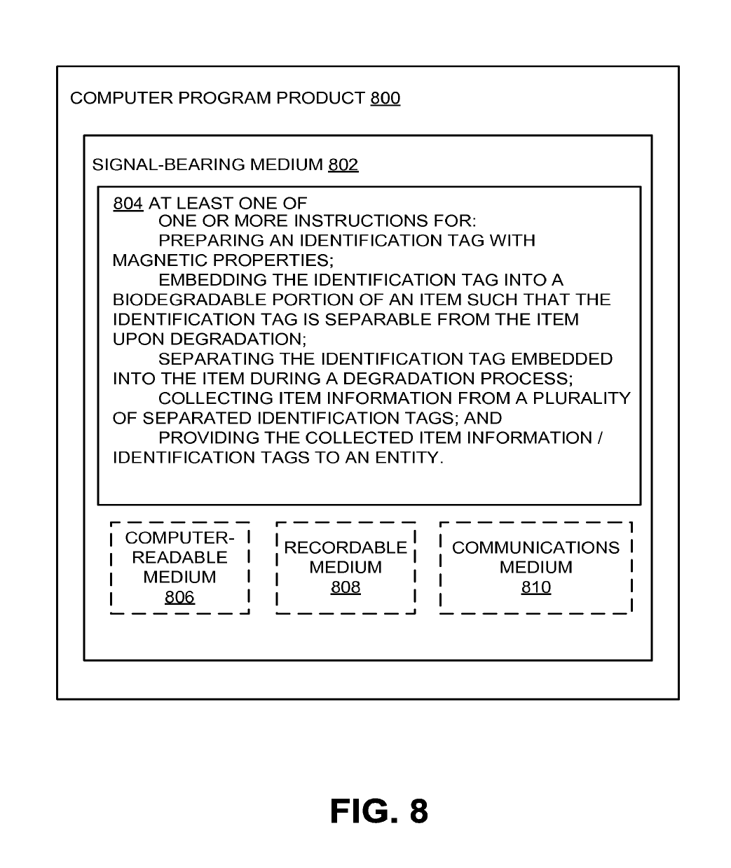

FIG. 8 illustrates a block diagram of an example computer program product, all arranged in accordance with at least some embodiments described herein. In some examples, as shown in FIG. 8, a computer program product 800 may include a signal bearing medium 802 that may also include machine readable instructions 804 that, when executed by, for example, a processor, may provide the functionality described above with respect to FIG. 6 and FIG. 7. Thus, for example, referring to the processor 504, the tag reading module 526 may undertake one or more of the tasks shown in FIG. 8 in response to the instructions 804 conveyed to the processor 504 by the signal bearing medium 802 to perform actions associated with the processes as described herein. Some of those instructions may include magnetizing an identification tag; embedding the identification tag into a biodegradable portion of an item such that the identification tag is separable from the item upon degradation; separating the identification tag embedded into the item during a degradation process; collecting item information from a plurality of separated identification tags; and providing the collected item information to an entity.

In some implementations, the signal bearing medium 802 depicted in FIG. 8 may encompass a computer-readable medium 806, such as, but not limited to, a hard disk drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, the program product 800 may be conveyed to one or more modules of the processor 504 by an RF signal bearing medium, where the signal bearing medium 802 is conveyed by a wireless communications medium 810 (e.g., a wireless communications medium conforming with the IEEE 802.11 standard).

According to some examples, a method for indicating proof of degradation for biodegradable materials may include embedding an identification tag into a biodegradable portion of an item comprising a biodegradable material such that the identification tag is separable from the item upon degradation, where the identification tag is destructible under one or more circumstances that destruct the item without the degradation.

The method may also include embedding the identification tag during an injection molding process such that the tag is not visible on a surface of the item, where the identification tag includes multiple protrusions to ensure the tag is not embedded in a vicinity of the surface of the item. The method may further include placing the identification tag between parts of the item that are bonded, where the parts of the item are bonded through sonic welding, riveting, thermal staking, or radio frequency (RF) staking. The identification tag may be an item-specific tag encoding information associated with the item. The identification tag may also be a hologram tag, a barcode tag, an acousto-magnetic label, a micro-wire tag, an optical reflection tag, or a radio frequency identification (RFID) tag.

The identification tag may include multiple trackers to determine a type and an amount of the biodegradable material that is degraded, where the trackers include micro-scale trackers, meso-scale trackers, milli-scale trackers, micro-taggants, rare earth oxides, or micro-particles. The method may further include preparing the identification tag with magnetic properties for collection during a degradation process through one or more of adding a ferrous powder to a tag backing material, employing a ferro-magnetic tag coating, or using one or more magnetically sortable tag components. The method may also include magnetizing the identification tag during manufacturing of the identification tag, prior to embedding the identification tag into the item, after embedding the identification tag into the item, or prior to separation at a degradation facility. A combination of product-specific tags and trackers may be embedded to identify biodegraded items and amount of biodegraded material, and an incentive may be provided to an entity collecting the identification tag during the degradation.

According to other examples, a system for indicating proof of degradation for biodegradable materials may include an identification tag selection module configured to select a suitable identification tag for an item including a biodegradable material and an integration module. The integration module may be configured to embed the identification tag into a biodegradable portion of the item such that the identification tag is separable from the item upon degradation, where the identification tag is destructible under one or more circumstances that destruct the item without the degradation.

The integration module may further embed the identification tag during an injection molding process such that the tag is not visible on a surface of the item, where the identification tag includes multiple protrusions to ensure the tag is not embedded in a vicinity of the surface of the item. The integration module may also place the identification tag between parts of the item that are bonded, where the parts of the item are bonded through sonic welding, riveting, thermal staking, or radio frequency (RF) staking. The identification tag may be an item-specific tag encoding information associated with the item. The identification tag may also be a hologram tag, a barcode tag, an acousto-magnetic label, a micro-wire tag, an optical reflection tag, or a radio frequency identification (RFID) tag.

The identification tag may include multiple trackers to determine a type and an amount of the biodegradable material that is degraded, where the trackers include micro-scale trackers, meso-scale trackers, milli-scale trackers, micro-taggants, rare earth oxides, or micro-particles. The integration module may prepare the identification tag with magnetic properties for collection during a degradation process through one or more of adding a ferrous powder to a tag backing material, employing a ferro-magnetic tag coating, or using one or more magnetically sortable tag components. The integration module may further embed a combination of product-specific tags and trackers to identify biodegraded items and amount of biodegraded material, and provide an incentive to an entity collecting the identification tag during the degradation.

According to further examples, a method for providing proof of degradation for biodegradable materials may include separating an identification tag embedded into a biodegradable portion of an item comprising a biodegradable material during a degradation process; collecting item information from multiple separated identification tags; and providing the collected item information to an entity.

The method may further include collecting the separated identification tags and providing the collected identification tags to the entity, where the identification tag is destructible under one or more circumstances that destruct the item without the degradation. The one or more circumstances that destruct the item without the degradation may include one or more of a temperature sufficient to burn the item, a mechanical destruction, and destruction by a solvent. The method may also include separating the identification tag during size sorting so that decomposed particulates are extracted and fragments of different sizes are mixed together in ratios to promote continued decomposition.

The method may further include separating the identification tag on one of a belt or a rotary sifter through magnetic sifting, where the identification tag is prepared with magnetic properties for collection during the degradation process. The identification tag may be embedded during an injection molding process such that the tag is not visible on a surface of the item. The identification tag may be placed between parts of the item that are bonded through sonic welding, riveting, thermal staking, or radio frequency (RF) staking.

The identification tag may be an item-specific tag encoding information associated with the item, where the identification tag is a hologram tag, a barcode tag, an acousto-magnetic label, a micro-wire tag, a optical reflection tag, or a radio frequency identification (RFID) tag. The identification tag may include multiple trackers to determine a type and an amount of the biodegradable material that is degraded. The trackers may include micro-scale trackers, meso-scale trackers, milli-scale trackers, micro-taggants, rare earth oxides, or micro-particles. A combination of product-specific tags and trackers may be embedded into the item to identify biodegraded items and amount of biodegraded material.

The entity may be a manufacturer of the item, a third party organization collecting recycling information, or a government agency. The method may also include receiving an incentive based on one or more of the collected item information and collected identification tags. The method may further include recovering the identification tag after degradation of the item and providing the recovered identification tag to the entity.

According to yet other examples, a system for providing proof of degradation for biodegradable materials may include a separation module, a collection module, and an administrative module. The separation module may be configured to separate an identification tag embedded into a biodegradable portion of an item comprising a biodegradable material during a degradation process. The collection module may be configured to collect item information from multiple separated identification tags. The administrative module may be configured to provide the collected item information to an entity.

The identification tag may be destructible under one or more circumstances that destruct the item without the degradation, where the one or more circumstances that destruct the item without the degradation include one or more of a temperature sufficient to burn the item, a mechanical destruction, and destruction by a solvent. The separation module may further separate the identification tag during size sorting so that decomposed particulates are extracted and fragments of different sizes are mixed together in ratios to promote continued decomposition. The separation module may separate the identification tag on one of a belt or a rotary sifter through magnetic sifting, where the identification tag is prepared with magnetic properties for collection during the degradation process.

The identification tag may be embedded during an injection molding process such that the tag is not visible on a surface of the item. The identification tag may be placed between parts of the item that are bonded through sonic welding, riveting, thermal staking, or radio frequency (RF) staking. The identification tag may be an item-specific tag encoding information associated with the item, where the identification tag is a hologram tag, a barcode tag, an acousto-magnetic label, a micro-wire tag, a optical reflection tag, or a radio frequency identification (RFID) tag. The identification tag may include multiple trackers to determine a type and an amount of the biodegradable material that is degraded, where the trackers include micro-scale trackers, meso-scale trackers, milli-scale trackers, micro-taggants, rare earth oxides, or micro-particles. A combination of product-specific tags and trackers may be embedded into the item to identify biodegraded items and amount of biodegraded material. The collection module may also recover the identification tag after degradation of the item and provide the recovered identification tag to the entity.

According to some examples, a computer-readable storage medium may have instructions stored thereon for providing proof of degradation for biodegradable materials. The instructions may include separating an identification tag embedded into a biodegradable portion of an item comprising a biodegradable material during a degradation process; collecting item information from multiple separated identification tags; and providing the collected item information to an entity.

The identification tag may be destructible under one or more circumstances that destruct the item without the degradation, where the one or more circumstances that destruct the item without the degradation include one or more of a temperature sufficient to burn the item, a mechanical destruction, and destruction by a solvent. The instructions may also include separating the identification tag during size sorting so that decomposed particulates are extracted and fragments of different sizes are mixed together in ratios to promote continued decomposition. The instructions may further include separating the identification tag on one of a belt or a rotary sifter through magnetic sifting, where the identification tag is prepared with magnetic properties for collection during the degradation process.

The identification tag may be embedded during an injection molding process such that the tag is not visible on a surface of the item. The identification tag may be placed between parts of the item that are bonded through sonic welding, riveting, thermal staking, or radio frequency (RF) staking. The identification tag may be an item-specific tag encoding information associated with the item, where the identification tag is a hologram tag, a barcode tag, an acousto-magnetic label, a micro-wire tag, a optical reflection tag, or a radio frequency identification (RFID) tag.

The identification tag may include multiple trackers to determine a type and an amount of the biodegradable material that is degraded, where the trackers include micro-scale trackers, meso-scale trackers, milli-scale trackers, micro-taggants, rare earth oxides, or micro-particles. A combination of product-specific tags and trackers may be embedded into the item to identify biodegraded items and amount of biodegraded material.

According to other examples, a computer-readable storage medium may have instructions stored thereon for indicating proof of degradation for biodegradable materials. The instructions may include embedding an identification tag into a biodegradable portion of an item comprising a biodegradable material such that the identification tag is separable from the item upon degradation, where the identification tag is destructible under one or more circumstances that destruct the item without the degradation.

The instructions may further include embedding the identification tag during an injection molding process such that the tag is not visible on a surface of the item and placing the identification tag between parts of the item that are bonded through sonic welding, riveting, thermal staking, or radio frequency (RF) staking. The identification tag may be an item-specific tag encoding information associated with the item. The identification tag may also include multiple trackers to determine a type and an amount of the biodegradable material that is degraded.

### EXAMPLES

Following are illustrative examples of how some embodiments may be implemented, and are not intended to limit the scope of embodiments in any way.

### Example 1: Biodegradable Computers

An environment-conscious and market-savvy computer company may manufacture computers with biodegradable enclosures and set up a recycling program, where returned computer enclosures are collected and sent to composting facilities for generating natural fertilizer. RFID tags encoded with computer type, serial number, and similar information may be embedded into the enclosures during manufacturing. The RFID tags and the trackers may be magnetized prior to embedding into the biodegradable computer enclosures. In addition, small-scale trackers may be embedded as well. The compost may be processed using a partially magnetized rotary drum, during which portions of the drum may be magnetized separating the RFID tags and the trackers from the broken down biodegradable material. The RFID tags and the trackers may then be separated from each other. An RFID reader may interrogate the tags retrieving computer type and serial number information. The trackers may be weighed or assayed to help determine an amount of the biodegradable material being processed. Subsequently, the composting facility may provide a report to the computer manufacturer with details of composted computer enclosures and amount of material that has been processed allowing the computer manufacturer to analyze the data and determine down to user level which computers have been recycled. The manufacturer may provide a financial incentive to the composting facility based on the received report. The composting facility may also keep the retrieved tags and trackers for a predefined period according to an audit policy of the computer manufacturer, or may provide them to a third party for evaluation.

### Example 2: Shoes to Fertilizer for Third World Farmers

A shoe manufacturer may use biodegradable material in its shoes marketed to environmentally conscious consumers. The marketing campaign may describe how returned shoes are composted at facilities in various third world countries generating fertilizer, which is then provided for free to small farmers as part of the company's good corporate citizenship program. The company may arrange for third party entities to set up recycling centers for easy drop off by consumers and delivery to the composting facilities. Upon arrival at a composting facility, hologram tags on the shoes (also advertising the environmental benefits of the shoes) may be magnetized prior to degradation process. During the degradation process, the compost pile may be passed over a band periodically for mixing and the hologram tags may be removed by a magnet hanging over the band. The tags may then be collected by the composting facility staff and provided to a third party entity, which may make a first part of the payment to the facility, the second part of the payment to be made when the resulting fertilizer is delivered to the farmers. The collected tags may be read optically and an analysis of which types of shoes are being recycled the most, etc. may be made for the shoe company's marketing department.

### Example 3: Compliance with Environmental Regulations

A regulatory agency may set up a new rule requiring at least a portion of plastic beverage bottles to be biodegradable and provide tax incentives to beverage sellers if they can provide proof of actual degradation. Because some of the bottles may be made using clear plastic, the bottle manufacturers may use micro-scale trackers invisible to the naked eye. A beverage sellers association may organize a program, where different types of trackers are assigned to different sellers such that the seller of a bottle can be identified from the micro-trackers in the bottle. A recycler may set up a program, where upon receiving recycled bottles, the micro-scale trackers may be separated from composting plastics at a magnetized drum, a band with a magnet, or similar setup. The recycler may then identify the types of different micro-scale trackers and provide a report to the regulatory agency based amounts of plastic degraded for each seller. The regulatory agency may compare the degraded plastic amount to sold bottles reported by each seller and compute tax incentives based on the percentage of successfully degraded plastic vs. sold plastic.

Example 4: Non-Compliant Recycling

A recycler may claim to have the capability to properly recycle (degrade) biodegradable products for a variety of manufacturers assisting them in their compliance with government regulations regarding recycling of products. If the manufacturers do not embed their products with identification tags or trackers to ensure proof of degradation, they can only rely on the claims of the recycler. For lack of capacity or other motives, the recycler may burn the returned products instead of properly composting them and fraudulently claim that the plastics have been degraded putting the manufacturers at risk of public shame or even government sanctions. In yet another scenario, some manufacturers may rely on the recycler's claims and not request further proof If the claims are not based on actual information retrieved from the tags (e.g., serial numbers of products, etc.) or only trackers are used in the products and the tags or trackers not collected for the manufacturers, the returned products may again be improperly disposed of (in a landfill or an incinerator). The tags or trackers may be destroyed in the process, but without a requirement to provide the tags, trackers, or specific information retrieved from the tags, proper recycling cannot be proven.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for indicating proof of degradation for biodegradable materials, the method comprising:
embedding an identification tag into a biodegradable portion of an item comprising a biodegradable material such that the identification tag is separable from the item upon degradation, wherein the identification tag is destructible under one or more circumstances that destruct the item without the degradation.

2. The method according to claim 1, further comprising:
embedding the identification tag during an injection molding process such that the tag is not visible on a surface of the item.

3. The method according to claim 2, wherein the identification tag includes a plurality of protrusions to ensure the tag is not embedded in a vicinity of the surface of the item.

4. The method according to claim 1, further comprising:
placing the identification tag between parts of the item that are bonded.

5. The method according to claim 4, wherein the parts of the item are bonded through one of sonic welding, riveting, thermal staking, or radio frequency (RF) staking

6. The method according to claim 1, wherein the identification tag is an item-specific tag encoding information associated with the item.

7. The method according to claim 6, wherein the identification tag is at least one of a hologram tag, a barcode tag, an acousto-magnetic label, a micro-wire tag, an optical reflection tag, or a radio frequency identification (RFID) tag.

8-13. (canceled)

14. A system for indicating proof of degradation for biodegradable materials, the system comprising:
an identification tag selection module configured to select a suitable identification tag for an item comprising a biodegradable material; and
an integration module configured to:
embed the identification tag into a biodegradable portion of the item such that the identification tag is separable from the item upon degradation, wherein the identification tag is destructible under one or more circumstances that destruct the item without the degradation.

15-20. (canceled)

21. The system according to claim 14, wherein the identification tag comprises a plurality of trackers to determine a type and an amount of the biodegradable material that is degraded.

22. The system according to claim 20, wherein the trackers comprise one from a set of: micro-scale trackers, meso-scale trackers, milli-scale trackers, micro-taggants, rare earth oxides, or micro-particles.

23. The system according to claim 14, wherein the integration module is further configured to:
prepare the identification tag with magnetic properties for collection during a degradation process through one or more of adding a ferrous powder to a tag backing material, employing a ferro-magnetic tag coating, or using one or more magnetically sortable tag components.

24. The system according to claim 23, wherein the identification tag is magnetized during manufacturing of the identification tag, prior to embedding the identification tag into the item, after embedding the identification tag into the item, or prior to separation at a degradation facility.

25. The system according to claim 14, wherein the integration module is further configured to:
embed a combination of product-specific tags and trackers to identify biodegraded items and amount of biodegraded material.

26. The system according to claim 14, further comprising an administrative module configured to:
provide an incentive to an entity collecting the identification tag during the degradation.

27. A method for providing proof of degradation for biodegradable materials, the method comprising:
separating an identification tag embedded into a biodegradable portion of an item comprising a biodegradable material during a degradation process, wherein the identification tag is destructible under one or more circumstances that destruct the item without the degradation;
collecting item information from a plurality of separated identification tags; and
providing the collected item information to an entity.

28-29. (canceled)

30. The method according to claim 28, wherein the one or more circumstances that destruct the item without the degradation include one or more of a temperature sufficient to burn the item, a mechanical destruction, and destruction by a solvent.

31. The method according to claim 27, further comprising:
separating the identification tag during size sorting so that decomposed particulates are extracted and fragments of different sizes are mixed together in ratios to promote continued decomposition.

32-39. (canceled)

40. The method according to claim 27, wherein the entity is one of a manufacturer of the item, a third party organization collecting recycling information, or a government agency.

41. The method according to claim 27, further comprising:
receiving an incentive based on one or more of the collected item information and collected identification tags.

42. The method according to claim 27, further comprising:
recovering the identification tag after degradation of the item; and
providing the recovered identification tag to the entity.

43-72. (canceled)
